(19) United States
(12) Patent Application Publication
(10) Pub. No.: US 2009/0070169 A1
(43) Pub. Date: Mar. 12, 2009

(54) VALUE ADDED BUSINESS MONITORING AND REPORTING SYSTEMS AND METHODS

(75) Inventor: Scott Cohen, Los Angeles, CA (US)

Correspondence Address: JAMES REMENICK;NOVAK DRUCE & QUIGG, LLP, 1300 I STREET NW, SUITE 1000 WEST TOWER, WASHINGTON, DC, 20005, US

(73) Assignee: Hedge Solutions, Inc., Los Angeles, CA (US)

(21) Appl. No.: 12/197,011

(22) Filed: Aug. 22, 2008

Related U.S. Application Data
(60) Provisional application No. 60/957,332, filed on Aug. 22, 2007.

(51) Int. Cl. G06Q 10/00; G06Q 40/00

(52) U.S. Cl. 705/7; 705/30

(57) ABSTRACT

Systems, method and reports, for executing calculating economic and tax capital balances at the partner/shareholder level for partnerships and unitized companies are disclosed. The system provides full reporting and allows for business information to be transmitted electronically and in multiple formats. The system also allows a user to retrieve a business entity's foundation documents within the system.

### REFERENCE TO RELATED APPLICATIONS

This invention claims priority to U.S. Provisional Application No. 60/957,332 entitled “A Value Added Business Monitoring and Reporting System and Method” filed Aug. 22, 2007, the entirety of which is hereby incorporated by reference.

### BACKGROUND

1. Field of the Invention

The invention is directed to business monitoring and, in particularly, methods and systems for storing and reporting business information.

2. Background of the Invention

The United States Securities and Exchange Commission (SEC) and most states require business entities to file numerous reports each year. Furthermore, for certain exemption laws, ERISA laws, etc., business entities must maintain specified compliance factors. Additionally, small businesses, such as partnerships, limited liability corporations (LLCs), closely held corporations, etc. must file reports regarding the composition of the business entity as well certain partner/shareholder facts.

Keeping track of all of the business's transactions, expenses, taxes, etc. in addition to each of the shareholder/partner's transactions, contributions, taxes, etc. can be a demanding and difficult task. Furthermore, all of this information is often not stored in the same location or even with the same person. Therefore it makes compiling reports based on the information more difficult because the information has to be located prior to compiling the reports.

Currently, such reports are often compiled by hand which can be a time consuming and inaccurate method. Additionally, the reports often need to be compiled by specialist trained in the field which can become quite costly because the business would have to hire a person specifically for this task or hire an outside company to make keep the information and make the reports. Furthermore, many of the necessary documents (such as the partnership agreement, the operating agreement, the articles of incorporation, articles of organization, and partner or shareholder subscription documents) are often stored in different locations or files.

Therefore, it is desirable to have a single system for storing, compiling, and generating all the necessary files and reports.

### SUMMARY OF THE INVENTION

The present invention overcomes the problems and disadvantages associated with current strategies and designs and provides a method and system for storing and reporting business information.

One embodiment of the invention is directed to methods of storing and reporting partner and shareholder information. The method includes the steps of inputting and storing data into a computing device, inputting and storing business entity information into the computing device, inputting and storing local and national business entity regulations on the computing device, summarizing the data inputted and stored on the computing device, generating financial records based on the summarized data, generating compliance reports based on the federal and state business entity regulations, and exporting the generated financial reports. Preferably, but not limited to, the business entity is a partnership, a limited liability company, or a closely held corporation. According to these methods, data and/or information can be manually or automatically inputted, such as automatically imputed from financial recording software.

According to the invention, the business entity information may include at least one of the partnership agreement, the operating agreement, the articles of incorporation, articles of organization, and partner or shareholder subscription documents. Local and national business entity regulations are based on United States state and federal laws such as, for example, the Securities Exchange Act of 1933, the Securities Exchange Act of 1934, Employee Retirement Income Security Act of 1974, and individual state securities laws.

According to the invention, the method includes at least one of calculating capital balance, tax capital of a partner or shareholder, tax liability, management fees, and incentive fees.

Another embodiment of the invention is directed to reports containing data, information and analysis according to the invention. Reports are preferably generated for an accounting period such as monthly, biweekly, a calendar quarter, bi yearly, annually or a combination of time periods. Reports may include, for example, the number of partners or shareholders and/or the ownership percentage of the entity.

Reports of the invention are preferably generated as a digital print-out, as a display on a screen, and/or as exported financial software. Compliance reports pertaining to partner or shareholder composition may be generated for the business entity. Preferably compliance reports identify states in which the identified business entity needs to comply with the local laws. Such reports may also include an alert if the business entity is not in compliance with a state's local laws. The alert may be a visual, on-screen alert and/or an audible alert. Also preferably, compliance reports include data, information and analysis pertaining to a pension plan of a business entity. Preferably, reports can be prepared for the individual partner or shareholder and/or include searching for individual partners or shareholders to target one or more reports.

Another embodiment of the invention is a system for storing and reporting partner and shareholder information. The system comprises a server, a processor in communication with the server, software executing on the processor, and an output device in communication with the server and processor. The software inputs data into a computing device, stores data in the computing device, inputs business entity information into the computing device, stores business entity information in the computing device, inputs local and national business entity regulations, stores local and national business entity regulations, summarizes the data inputted and stored on the computing device, generates financial records based on the summarized data, generates compliance reports based on the federal and state business entity regulations, and exports the generated financial reports. The business entity is preferably a partnership, a limited liability company, or a closely held corporation. Data and information is manually or automatically inputted such as, for example, automatically imputed from financial recording software. Preferably business entity information comprises at least one of the partnership agreement, the operating agreement, the articles of incorporation, articles of organization, and partner or shareholder subscription documents. The local and national business entity regulations are preferably based on United States state and federal laws such as, for example, the Securities Exchange Act of 1933, the Securities Exchange Act of 1934, Employee Retirement Income Security Act of 1974, or individual state securities laws. Systems of the invention preferably comprise the methods of the invention as well.

Another embodiment of the invention a computer-readable media containing program instructions for storing and reporting business entity information wherein the business entity is owned by one or more stakeholders. The computer-readable media directs a computer to receive and store business entity information, receive and store business entity regulations, compile data based on the received and stored business entity information, compare the compiled data to the received and stored business entity regulations for compliance with the business entity regulations, generate a compliance report based on the compared data, and export the generated compliance report.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 is a screen shot of the data input window.

FIG. 2 is a screen shot of the investor input window.

FIG. 3 is a screen shot of the period activity window.

FIG. 4 is a screen shot of the compliance and statistics window.

FIG. 5 is a screen shot of the partner/shareholder allocation screen.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

Intimate knowledge of the finances and structure of another business entity, as well as one's own, are necessary to survive in today's economy. It has been surprisingly discovered that the tracking and reporting of business information can be coupled with an analysis function to determine compliance with local, state, federal, and international rules, statutes, regulations, laws, treaties, and other such procedures. By utilizing such methods, compliance issues can be identified long before they become problems. Further, identification can lead to increased business opportunities by simply being in the right place at the right time, electronically speaking. Business entities include, but are not limited to, partnerships, companies, limited liability companies or partnerships, corporations (e.g. S, C, for profit or not-for-profit, closely held, mutual benefit corporations), voluntary associations, sole proprietorships, trusts, estates, and funds including hedge funds, mutual funds, and investor portfolios. The business entity may be large or small (e.g. as defined by the Small Business Administration under the Small Business Act of 1953), and is preferably a partnership, a limited liability company, a closely held corporation or a small business entity with a finite number of partners or shareholders.

The invention is directed to methods, systems and reports that are generated for company stakeholders and other third parties. Stakeholders are preferably individuals, but a stakeholder may on occasion be a business entity. Stakeholders are directly involved in one or more aspects of the business of the entity such as voting or non-voting members of the business entity and preferably shareholders or partners. Stakeholders may or may not be involved in the decision-making process of the business, but have a financial interest in the successful outcome of the business entity.

Software of the invention may be able to run on Microsoft Windows based computers, Apple OS based computers, or any other type of computer operating system. The initial screen may include a number of pull down menus as well as functional icons. Navigation through the software may be accomplished via pull down menus, functional icons, and tabs. The software may be used for storing financial data about a business entity, as well as, storing structural information about the entity.

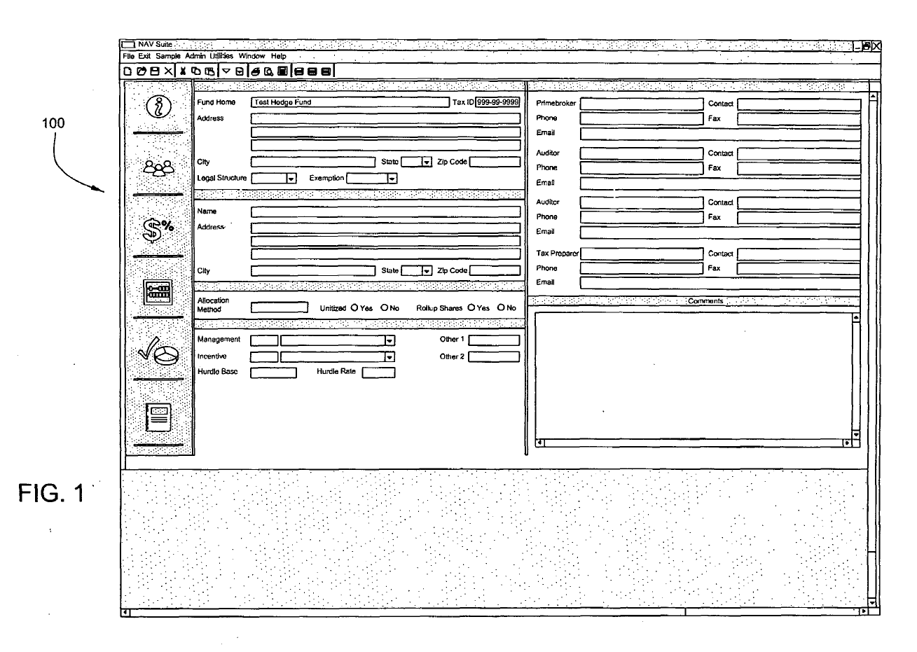

FIG. 1 is an image of a data input window 100 for inputting general partner/shareholder information. In this embodiment entry fields and reports are on one or more tabs within the same window or with in multiple windows. However, in other embodiments, the entry fields and reports can be separated onto one or more windows. The software may allow for inputting data either manually, electronically or both. Furthermore, the software is preferably able to accept data from other computer programs, such as, but not limited to, Microsoft Excel, Intuit's Quicken, NetSuite, or any other financial or data manipulating software. As can be seen in window 100, a user may be able to input personal information about partners/shareholders, data related to the business entity, accounting rules, fees, and information about service providers.

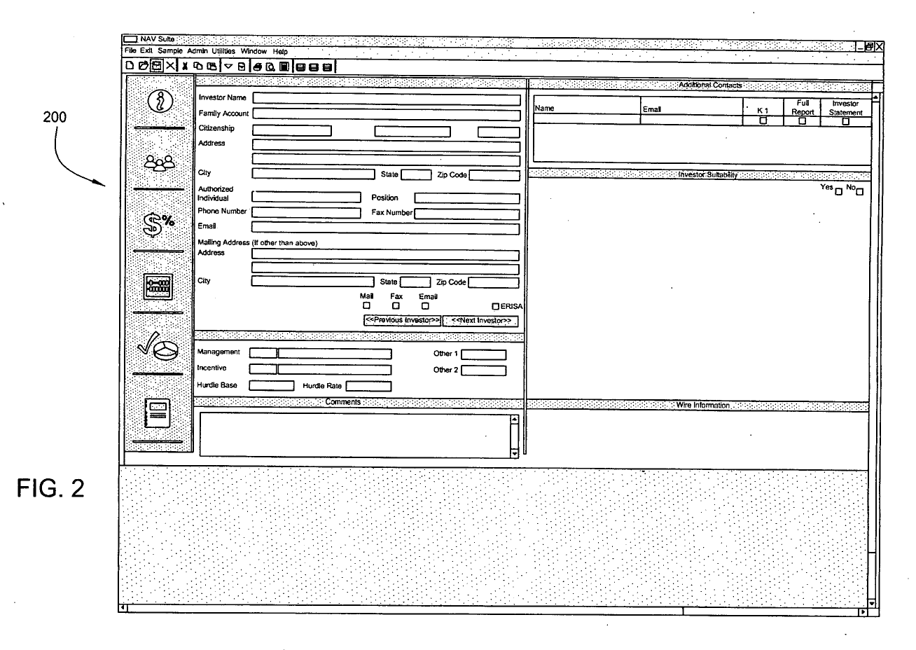

FIG. 2 is an image of an investor input window 200 for inputting investor information. Window 200 may allow for additional partner/shareholder personal information to be entered. Window 200 may further allow for fee data to be entered.

All data entered into the software or electronically received by the software may be stored on a server. The software may compile the data into one or more databases stored on the server for use in compliance reports or statistical analysis. Additionally, the software may be adapted to store business entity information. Such information may include, but is not limited to, partnership agreements, operating agreements, articles of incorporation, articles of organization, partner/shareholder subscription documents, annual or quarterly reports, 10K's, 10 Q's, SEC and other federal and local agency requirements or orders, Bylaws, company policies and procedures, compliance orders or requests from a local or a federal government agency, amendments of any to the preceding materials, or other necessary, required or relevant documents pertinent to the operation of the business entity. Such documents are preferably able to be viewed by a user without exiting the software.

Local and national business entity regulations, such as state and federal laws may be able to be either manually or automatically entered into the software and stored on the server. Such business entity regulations may be based on the Securities Exchange Act of 1933, the Securities Exchange Act of 1934, Employee Retirement Income Security Act (“ERISA”) of 1974, and individual state securities laws, including “Blue Sky Laws,” or any other type of business regulation.

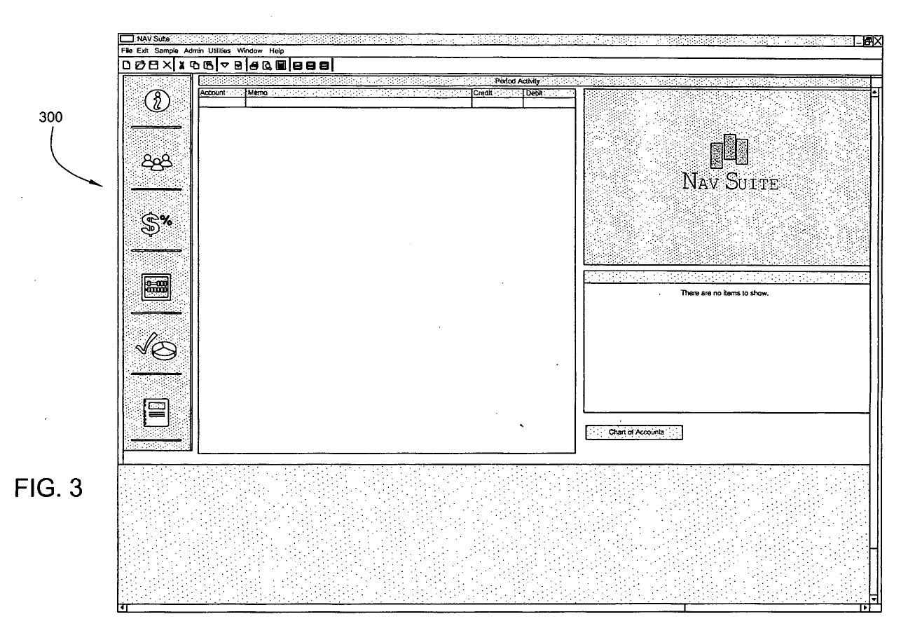

FIG. 3 is an image of a period activity window 300 for inputting partner/shareholder transactions. Window 300 may allow for entering financial data related to the partner/shareholder. The software may compile the data stored on the server and window 300 may display such summary. The compiled data may be added to the database(s) stored on the server.

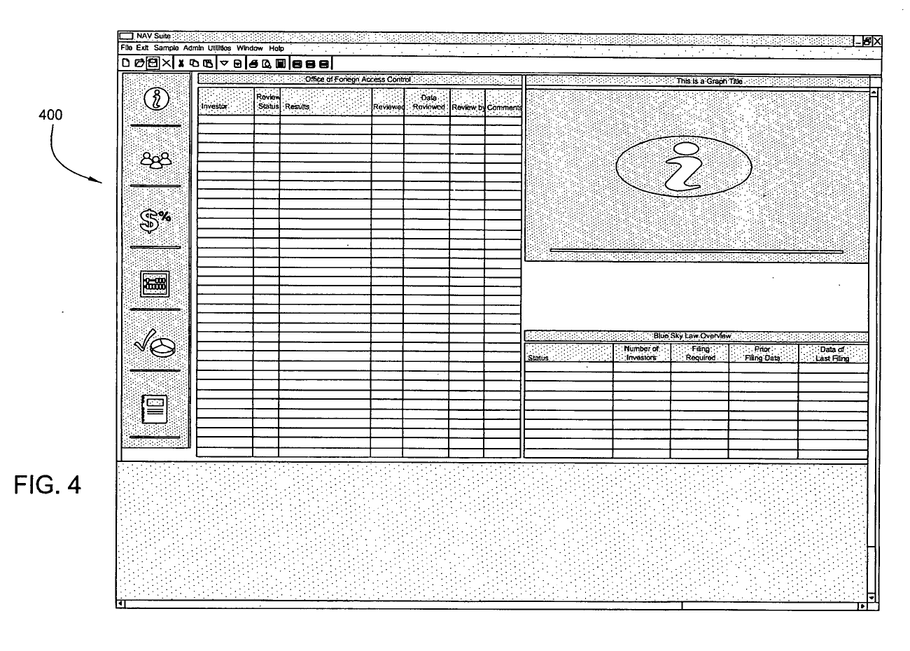

FIG. 4 is an image of a compliance and statistics window 400 for showing compliance reports and generated statistics, including graphical representations of the data. Compliancy reports and statistics may be generated based on the inputted business entity data and the regulations inputted into the software and stored on the server. The data may be compiled on the server and then compared to the imputed rules, regulations, etc. The compliancy reports may include, but are not limited to, partner or shareholder composition for the business entity, which laws the business is or is not in compliance with, the business entity's pension plans, or any other regulations that the business entity may need to comply with. The software may alert the user if the business entity is not in compliance with a rule or regulation through visual, on-screen alerts, audible sounds, or any other means of notifying the user. The business statistics may also be compiled and reported to the user. Business statistics may include, but are not limited to, shareholder/partner ownership percentages, business holdings, contributions to the business, outstanding debt, outstanding invoices, employment records, income records, sales records, etc. The business statistics may be reported in chart form, graph form, or any other form to convey the data. Furthermore, financial reports and tax reports may be generated. Such reports may be based on the inputted and compiled data that is compared to the local and/or federal laws and regulations. The reports may include, but are not limited to, capital balance reports, tax capital of a partner/shareholder reports, tax liability reports, management fees reports, incentive fees reports, contribution reports, income or expense reports, expense receipts, or any other relevant documents. Such fees and expenses may be calculated at the partner/shareholder level. Furthermore, the records may be generated for specific accounting periods and may include the number of partners/shareholders and/or the ownership percentages.

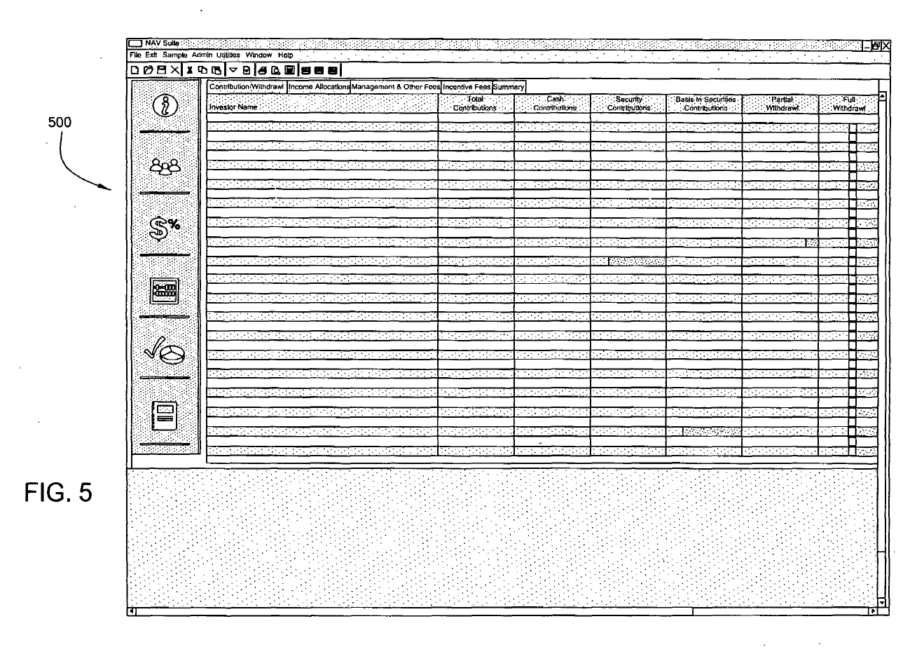

FIG. 5 is an image of a partner/shareholder allocation screen 500. Users may be able to search for individual partners/shareholders and request reports pertaining to those individuals. The software may also be able to monitor the partner/shareholder composition of the business entity and generate reports accordingly. The stakeholder composition reports may be based on ownership percentage, stakeholder contributions, type of partners or shareholders, contributions/withdrawals, income allocations, management fees, incentive fees, expenses, assets and asset allocation, depreciation calculations, payroll reports, and the like. The software will preferably output the reports in multiple formats, including but not limited to, on screen, print-out, exporting the reports to other software, or any other type of electronic output.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. Furthermore, the term “comprising” includes the terms “consisting of” and “consisting essentially of.” It is intended that the specification and examples be considered exemplary only with the true scope and spirit of the invention indicated by the following claims.

1. A method of storing and reporting business entity information wherein the business entity is owned by one or more stakeholders, comprising the steps of:
inputting and storing business entity information into a computing device;
inputting and storing business entity regulations into the computing device;
compiling data based on the entered and stored business entity information;
comparing the compiled data to the inputted and stored business entity regulations for compliance with the business entity regulations;
generating a compliance report based on the compared data; and
exporting the generated compliance report.

2. The method of claim 1, wherein the business entity is a partnership, a limited liability company, or a closely held corporation.

3. The method of claim 1, wherein business entity information is inputted manually or electronically.

4. The method of claim 3, wherein the data and business entity information is input electronically from financial recording software.

5. The method of claim 1, wherein the business entity information is selected from the group consisting of information from a partnership agreement, an operating agreement, articles of incorporation, articles of organization, partner or shareholder subscription information and combinations thereof.

6. The method of claim 1, wherein the business entity regulations are based on state law, federal law, or both.

7. The method of claim 6, wherein the business entity regulations are selected from the group consisting of the Securities Exchange Act of 1933, the Securities Exchange Act of 1934, Employee Retirement Income Security Act of 1974, state securities laws and combinations thereof.

8. The method of claim 1, wherein compiling the data comprises determining capital balance, tax capital of a partner or shareholder, tax liability, management fees, or incentive fees.

9. The method of claim 1, wherein the report is generated for an accounting period.

10. The method of claim 9, wherein the accounting period is biweekly, monthly, by calendar quarter, by-yearly, yearly or a combination thereof.

11. The method of claim 1, wherein the compliance report contains information on:
the number of stakeholders of the business entity; and
the ownership percentage of each stakeholder of the business entity.

12. The method of claim 1, wherein the compliance report is exported to a digital print-out, exported for display on a monitor, or exported to financial software.

13. The method of claim 1, wherein the compliance report is prepared for one or more stakeholders of the business entity.

14. The method of claim 1, wherein the compliance report contains compulsory information necessary for the business entity to comply with federal, state or both federal and state business entity regulations.

15. The method of claim 1, further comprising an alert system to identify when the business entity is not in compliance with one or more business entity regulations.

16. The method of claim 15, wherein the alert system comprises a visual, on-screen alert or an audible alert.

17. The method of claim 1, wherein the compliance report contains information about a pension plan of the business entity.

18. The method of claim 1, further comprising storing business entity documents.

19. A system for storing and reporting business entity information wherein the business entity is owned by one or more stakeholders, comprising:
a server;
a processor in communication with the server;
software executing on the processor,
wherein the software inputs data into a computing device, stores data in the computing device, inputs business entity information into the computing device, stores business entity information in the computing device, inputs local and national business entity regulations, stores local and national business entity regulations, summarizes the data inputted and stored on the computing device, generates financial records based on the summarized data, generates compliance reports based on the federal and state business entity regulations, and exports the generated financial records and compliance reports; and
an output device in communication with the server and processor to export the generated financial records and compliance reports.

20. A computer-readable media containing program instructions for storing and reporting business entity information wherein the business entity is owned by one or more stakeholders, that causes a computer to:
receive and store business entity information;
receive and store business entity regulations;
compile data based on the received and stored business entity information;
compare the compiled data to the received and stored business entity regulations for compliance with the business entity regulations;
generate a compliance report based on the compared data; and
export the generated compliance report.
